(19) United States
(12) Patent Application Publication
(10) Pub. No.: US 2016/0335908 A1
(43) Pub. Date: Nov. 17, 2016

(54) SET OF EDUCATIONAL BLOCKS

(71) Applicant: GLENN JAWITZ, INWOOD, NY (US)

(72) Inventor: GLENN JAWITZ, INWOOD, NY (US)

(21) Appl. No.: 14/710,543

(22) Filed: May 12, 2015

(51) Int. Cl. G09B 17/00; G09B 1/34

(52) U.S. Cl. CPC G09B 17/00; G09B 1/34

(57) ABSTRACT

The set of educational blocks includes a plurality of blocks, each having a plurality of sides. Each side of each block has unique and distinctive indicia printed thereon, such that the unique and distinctive indicia of each of the sides of a single one of the blocks represents a variant of a single unique symbol. When the single unique symbol is an alphabetic letter associated with the particular block, each side of the block may have a unique variant of that letter printed thereon, such as, a formal book script representation of the alphabetic letter, a cursive representation of the alphabetic letter, an informal representation of the alphabetic letter simulating a handwritten version thereof, or any other desired variation. Additionally, each side of each block may have a unique and distinctive color associated therewith corresponding to a particular one of the variants of the single unique symbol.

### BACKGROUND OF THE INVENTION

1. Field of the Invention

The present invention relates to educational materials, and particularly to a set of educational blocks for teaching a plurality of variants of individual members of a larger set, such as variant versions of alphabetic letters.

2. Description of the Related Art

The usage of blocks for educational purposes is well known. For example, children commonly use blocks imprinted with letters in order to gain familiarity with the alphabet and, later, learn how to spell words. Although blocks are regularly used to teach children individual members of sets (e.g., individual letters in an alphabetic set) and how to combine these individual members into subsets and associate the members with the set as a whole, such relatively simple blocks do not teach variants on the individual members of the set. For example, alphabet blocks are typically imprinted with capital block letters of the same type, thus requiring the purchase and combination of additional sets of blocks to teach, for example, lowercase letters, or letters written in cursive.

Thus, a set of educational blocks solving the aforementioned problems is desired.

### SUMMARY OF THE INVENTION

The set of educational blocks includes a plurality of blocks, where each block has a plurality of sides. Each side of each block has unique and distinctive indicia printed thereon, such that the unique and distinctive indicia of each of the sides of a single one of the blocks represents a variant of a single unique symbol. The single unique symbol can be a unique alphabetic letter associated with the particular block, and each side of the block may have a unique variant of that letter printed thereon, such as, a formal book script representation of the alphabetic letter, a cursive representation of the alphabetic letter, an informal representation of the alphabetic letter simulating a handwritten version thereof, or any other desired variation. Additionally, each side of each block may also have a unique and distinctive color and/or face associated therewith corresponding to a particular one of the variants of the single unique symbol.

In the example where the single unique symbol is an alphabetic letter, the user may form a subset of the blocks into a word using the alphabetic letters associated therewith. The user can align the sides of the blocks in the subset such that the sides of adjacent ones of the blocks in the subset have matching colors, and the word is displayed in the variants of the alphabetic letters forming the word. For example, the word may be presented in formal book script when viewed from above, in cursive when viewed from the front, and in an informal handwritten version when viewed from the rear. In this way, the user may learn each writing variant simultaneously.

It should be understood that the above example is provided for illustrative purposes only. The complete set of educational blocks forms a “master set”, where each individual block is a member of that master set, and each side of a particular block includes unique and distinctive indicia, which corresponds to similar (but not identical) indicia on the corresponding sides of other blocks. In this way, the sum total of the unique and distinctive indicia on the blocks forms a separate, distinct, independent and particular set (or sub-set) unto itself, different from any other set of unique and distinctive indicia, but related thereto by way of the similarity of the plurality of sides of any particular block.

These and other features of the present invention will become readily apparent upon further review of the following specification and drawings.

### BRIEF DESCRIPTION OF THE DRAWINGS

FIG. 1 is a perspective view of a set of educational blocks according to the present invention.

FIG. 2A is a perspective view of a single block of the set of educational blocks.

FIG. 2B is a perspective view, at a different angle, of the single block of FIG. 2A.

FIG. 3 is an unfolded plan view of a single block of the set of educational blocks.

Similar reference characters denote corresponding features consistently throughout the attached drawings.

### DETAILED DESCRIPTION OF THE PREFERRED EMBODIMENTS

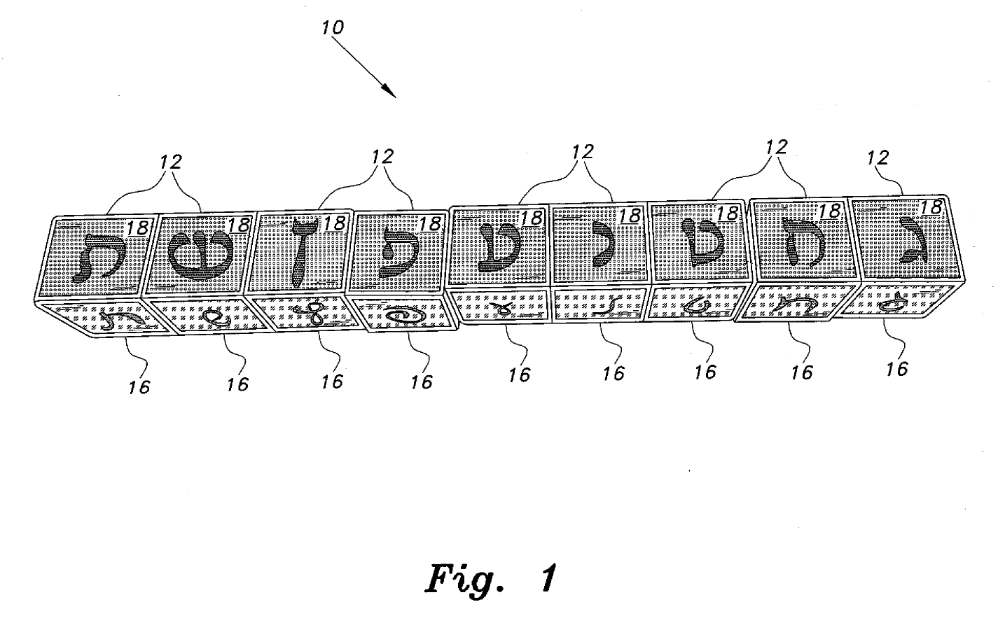

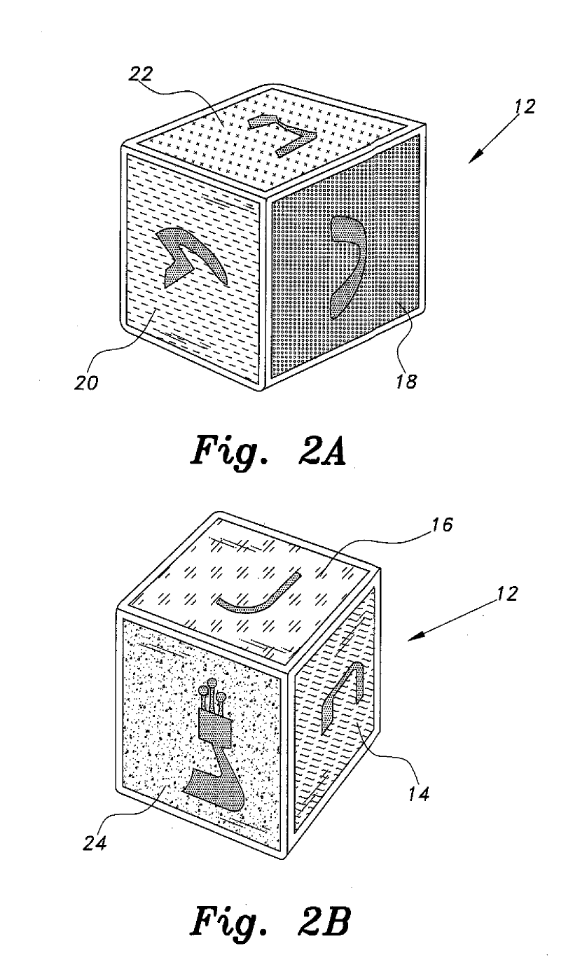

Referring now to FIGS. 1, 2A and 2B, the set of educational blocks 10 includes a plurality of individual blocks 12. Each block 12 is three-dimensional and has a plurality of sides. Although shown as being conventional cubical blocks in the Figures, with each block 12 having six sides of equal dimension, it should be understood that this configuration is shown for exemplary purposes only, and that blocks 12 may have any desired overall contouring or relative dimensions.

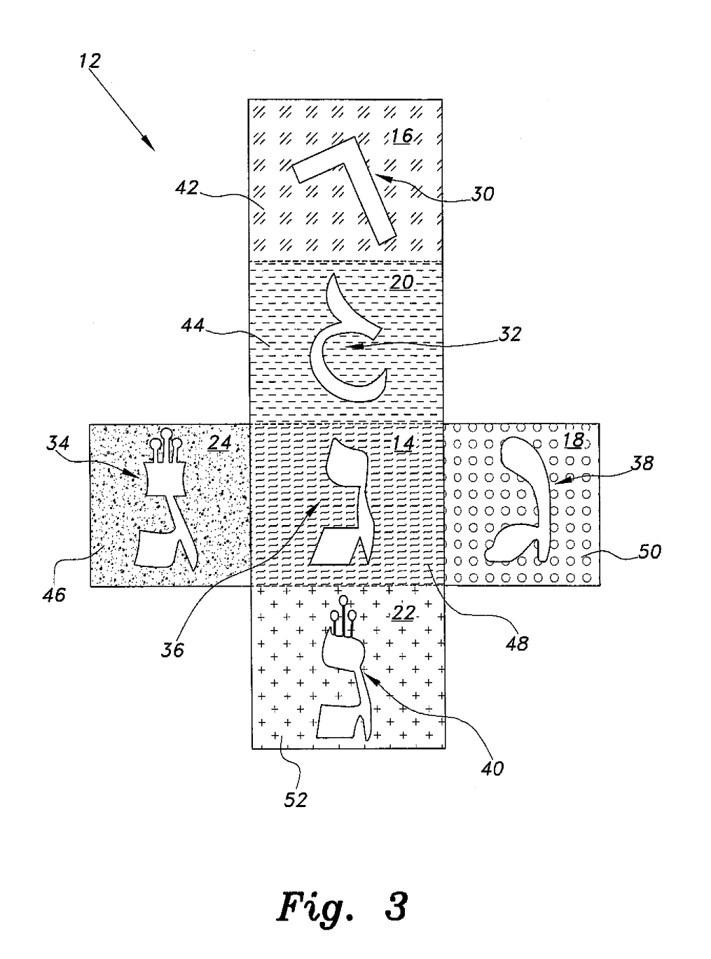

As shown, each side of each block 12 has unique and distinctive indicia printed thereon, such that the unique and distinctive indicia of each of the sides of a single one of the blocks 12 represents a variant of a single unique symbol. As best seen in FIGS. 2A, 2B and particularly FIG. 3, in an example where the single unique symbol is a unique alphabetic letter associated with the particular block 12, each side of the block 12 may have a unique variant of that letter printed thereon. Referring to the particular example of FIG. 3, the single unique symbol associated with the particular block 12 is the Hebrew letter “gimel”. Side or face 14 has a gimel 36 imprinted thereon which is written in a formal book script representation. Side or face 16 has a gimel 30 imprinted thereon in cursive. Side or face 18 has indicia 38 simulating a handwritten version of the gimel (also referred to as “Rashi script”, an informal, semi-cursive typeface). Side or face 20 has indicia 32 representative of a gimel written in Old Hebrew. Sides 22 and 24 include further variants on the Hebrew letter gimel 40, 34, respectively. Specifically, in this example, side 24 represents “Askenazi Torah” script and side 22 represents “Sefardi Torah” script. It should be understood that any desired variant may be used. Further, it should be understood that the single unique symbol associated with a particular block 12 does not have to be a Hebrew letter or an alphabetic letter of any language, but can be any member of any desired set.

Additionally, each side of each block 12 may also have a unique and distinctive color associated therewith corresponding to a particular one of the variants of the single unique symbol. In FIG. 3, each of the indicia representative of variations on the gimel (in this particular example) 30, 32, 34, 36, 38, 40, respectively printed on one of sides 16, 20, 24, 14, 18, 22, also has a unique color (represented by patterns in the drawings) associated therewith. The corresponding side or face of each block 12 can be colored with one of unique colors 42, 44, 46, 48, 50, 52, respectively. It should be understood that any desired colors or hues may be used, and that the particular matching of alphabetic styles with particular shades in the Figures is shown for exemplary purposes only.

In FIG. 1, the set of educational blocks 10 is shown with a plurality of blocks 12, each having a different Hebrew letter associated therewith. It should be understood that the set of Hebrew letters is shown for exemplary and illustrative purposes only, and that the set of educational blocks 10 may represent any desired set, including sets of alphabetic letters, sets of associated symbols, sets of numbers, sets of mathematical symbols, sets of words or any other desired set. In the particular example where words are used as the distinctive indicia on blocks 12, each side of a particular block 12 could include a particular word in a distinct language; i.e., a selected word could be assigned to a particular block 12, and each face of the block 12 would have that word imprinted thereon in a different language.

It should be understood that the above alphabetic example is provided for illustrative purposes only. The complete set of educational blocks 10 forms a “master set”, where each individual block 12 is a member of that master set 10, and each side of a particular block 12 includes unique and distinctive indicia, which corresponds to similar (but not identical) indicia on the corresponding sides of other blocks 12. In this way, the sum total of the unique and distinctive indicia on the blocks 12 forms a separate, distinct, independent and particular set (or sub-set) unto itself, different from any other set of unique and distinctive indicia, but related thereto by way of the similarity of the plurality of sides of any particular block 12.

As shown in FIG. 1, in use, the blocks 12 of the overall set 10 may be arranged such that the particular variants on the letters are aligned; i.e., in the case where color variations are used, the sides of the blocks 12 with matching colors may be aligned with one another, thus also aligning the faces of the blocks 12 which are all written in the same variant. In the exemplary configuration of FIG. 1, side or face 18 of each block 12 faces upwardly. This represents the informal handwritten version of each letter. If each side or face 18 is colored yellow, for example, then the user could quickly match the yellow faces to learn the informal handwritten version of each letter all at once. The side 16 which is facing frontward in the exemplary configuration of FIG. 1 represents the cursive version of each letter. This side may be colored differently from side 18 (orange, for example), allowing the user to easily align the blocks 12 in the right direction. In this example, where the single unique symbol is an alphabetic letter, the user may form a subset of the blocks 12 into a word (or any other desired pattern of letters) using the alphabetic letters associated therewith. The user then aligns the sides of the blocks 12 in the subset such that the sides of adjacent ones of the blocks 12 in the subset have matching colors, such that the word is displayed in the variants of the alphabetic letters forming the word. In the example of FIG. 1, the word is presented, when viewed from above, in the informal handwritten variant, and is also presented in cursive when viewed from the front. In this way, the user may learn each writing variant (or variant set) simultaneously; i.e., the user can simultaneously learn not only the variants of a particular block 12, but also simultaneously learn the entirety of variant sets. Alternatively, as the user learns a particular variant set by itself, the user may automatically gain knowledge of the other variant sets during the individual learning of the particular set.

In reference to the above, using the Hebrew alphabet as an example, variant sets of Hebrew letters are typically learned as a whole; i.e., individually, separate and distinct from learning the other variants. For example, a student typically learns the printed form of a letter (such as gimel 36 of FIG. 3) by itself, or possibly alongside its cursive form (such as gimel 30). Alternatively, the cursive form might be learned by itself at another date. The Rashi script variant (such as gimel 38 of FIG. 3) is a variant form of the Hebrew alphabet that would typically be independently learned as a set unto itself at another time. Ashkenazi Torah script (such as gimel 34 of FIG. 3) is another variant form that would typically be learned as a set unto itself, as would Sefardi Torah script (gimel 40 of FIG. 3). Similarly, “Old Hebrew”, such as gimel 32, is yet another variant form that would be learned as a set unto itself. Using the set of educational blocks 10, a student may learn all of these variants simultaneously, or learn selected variants simultaneously.

It should be understood that in addition to the indicia, as described above, taken alone or in combination with colors corresponding thereto, any other desired indicia or other markings may be utilized, such as, for example, informative content descriptive of a particular variant (such as “Old Hebrew” printed on face 20 of FIG. 3) or of the block as a whole (such as “Hebrew Alphabet” in this particular example) or, alternatively, instructional/informational designations indicating proper direction and/or positioning for placement of the block, etc. It should be understood that any suitable desired type of indicia, marking or other types of indication (such as texturing or the like) may be added to the blocks, including one or more blank faces on a block.

It is important to reiterate that although FIGS. 2A and 2B show a Hebrew letter “nun” and FIG. 3 shows a Hebrew gimel, the usage of Hebrew letters as the selected indicia in FIGS. 1-3 is for exemplary purposes only, and that the set of educational blocks 10 may represent any desired set, not limited to alphabetic letters. It should be further understood that the indicia may be imprinted or otherwise formed on each block in any suitable manner, such as by painting, typing, printing, etching, carving or the like. It should also be understood that the blocks 12 may be formed from any suitable material, such as wood, plastic, metal or the like. As noted above, blocks 12 are shown as having substantially cube-shaped contouring, with six faces per block, though it should be understood that this is shown for exemplary purposes only, and that any suitable shape of block, with any desired number of faces, may be utilized.

It is to be understood that the present invention is not limited to the embodiments described above, but encompasses any and all embodiments within the scope of the following claims.

I claim:

1. A set of educational blocks, comprising a plurality of blocks, wherein each said block has a plurality of sides, each said side of each said block having unique and distinctive indicia printed thereon, such that the unique and distinctive indicia of each of the sides of a single one of the blocks comprises a variant of a single unique symbol.

2. The set of educational blocks as recited in claim 1, wherein the single unique symbol of each said block is an alphabetic letter.

3. The set of educational blocks as recited in claim 1, wherein the single unique symbol of each said block represents a first sub-set of a larger set.

4. The set of educational blocks as recited in claim 3, wherein the plurality of blocks represents the larger set.

5. The set of educational blocks as recited in claim 4, wherein similar ones of the variants of the plurality of blocks represent a second sub-set of the larger set.

6. The set of educational blocks as recited in claim 1, wherein each said side of each said block has a unique and distinctive color associated therewith corresponding to a particular one of the variants of the single unique symbol.

7. The set of educational blocks as recited in claim 1, wherein each said block has a cubical contour.

8. The set of educational blocks as recited in claim 1, wherein the single unique symbol of each said block is a word.

9. A set of educational blocks, comprising a plurality of blocks, wherein each said block has a plurality of sides, each said side of each said block having unique and distinctive indicia printed thereon, such that the unique and distinctive indicia of each of the sides of a single one of the blocks comprises a variant of a single unique alphabetic letter.

10. The set of educational blocks as recited in claim 9, wherein the variants of the single unique alphabetic letter include a formal book script representation of the alphabetic letter and a cursive representation of the alphabetic letter.

11. The set of educational blocks as recited in claim 10, wherein the variants of the single unique alphabetic letter further include an informal representation of the alphabetic letter simulating a handwritten version thereof.

12. The set of educational blocks as recited in claim 9, wherein each said side of each said block has a unique and distinctive color associated therewith corresponding to a particular one of the variants of the single unique symbol.

13. The set of educational blocks as recited in claim 9, wherein each said block has a cubical contour.

14. An educational method using a set of blocks, comprising the steps of:
providing a plurality of blocks, wherein each said block has a plurality of sides, each said side of each said block having unique and distinctive indicia printed thereon, such that the unique and distinctive indicia of each of the sides of a single one of the blocks comprises a variant of a single unique alphabetic letter, each said side of each said block further having a unique and distinctive color associated therewith corresponding to a particular one of the variants of the single unique symbol;
forming a subset of the plurality of blocks into a word using the alphabetic letters associated therewith; and
aligning the sides of the blocks in the subset such that the sides of adjacent ones of the it blocks in the subset have matching colors, such that the word is displayed in the variants of the alphabetic letters forming the word.
